(19) United States
(12) Patent Application Publication
(10) Pub. No.: US 2019/0347690 A1
(43) Pub. Date: Nov. 14, 2019

(54) INFORMATION PROVISION APPARATUS, TERMINAL, AND INFORMATION PROVISION METHOD

(71) Applicant: TOYOTA JIDOSHA KABUSHIKI KAISHA, Toyota-shi (JP)

(72) Inventors: Koichi SUZUKI, Miyoshi-shi (JP); Katsunori TAKAMI, Tachikawa-shi (JP)

(73) Assignee: TOYOTA JIDOSHA KABUSHIKI KAISHA, Toyota-shi (JP)

(21) Appl. No.: 16/387,670

(22) Filed: Apr. 18, 2019

(30) Foreign Application Priority Data
May 8, 2018 (JP) 2018-090175

(51) Int. Cl. G06Q 30/02

(52) U.S. Cl. CPC G06Q 30/0255; G06Q 30/0267

(57) ABSTRACT

An information provision apparatus includes a screen provision unit configured to transmit, to a terminal of the customer, screen information having first sale promotion information, and second sale promotion information that matches the preference information at a higher level than that of the first sale promotion information, a progress management unit configured to change a display mode of the first sale promotion information and the second sale promotion information displayed on the screen of the terminal, and a benefit provision unit configured to provide additional sale promotion information to the terminal when a layout of the first sale promotion information and the second sale promotion information on the screen, of which the display mode has been changed, satisfies a predetermined condition.

### INCORPORATION BY REFERENCE

The disclosure of Japanese Patent Application No. 2018-090175 filed on May 8, 2018 including the specification, drawings and abstract is incorporated herein by reference in its entirety.

### BACKGROUND

### 1. Technical Field

The disclosure relates to an information provision apparatus, a terminal, and an information provision method.

### 2. Description of Related Art

There is a technology that provides sale promotion information, such as a coupon, to a customer via a mobile terminal, so as to attract a customer to a place where a sale promotion is taking place, such as a store providing goods or services. For example, Japanese Unexamined Patent Application Publication No. 2011-090616 (JP 2011-090616 A) discloses a system that delivers a bingo sheet in which a square is validated on a customer's mobile terminal when the customer visits a store.

### SUMMARY

However, with a technology disclosed in JP 2011-090616 A, although it is possible to attract a customer to a store that matches the customer's preference, it is not possible to attract a customer to a store that does not match the customer's preference.

The present disclosure provides an information provision apparatus, a terminal, and an information provision method to more efficiently provide sale promotion information to a customer.

An information provision apparatus according to a first aspect of the present disclosure includes an acquisition unit configured to acquire sale promotion information including at least first sale promotion information and second sale promotion information, a storage unit configured to have preference information of a customer, a screen provision unit configured to transmit, to a terminal of the customer, screen information having the first sale promotion information, and the second sale promotion information that matches the preference information at a higher level than that of the first sale promotion information, a progress management unit configured to detect that the customer has used the first sale promotion information and the second sale promotion information, and to change a display mode of the first sale promotion information and the second sale promotion information that are displayed on the screen of the terminal based on the screen information, and a benefit provision unit configured to provide additional sale promotion information to the terminal when a layout of the first sale promotion information and the second sale promotion information on the screen, of which the display mode has been changed, satisfies a predetermined condition.

The predetermined condition may be forming a line in which the first sale promotion information and second sale promotion information used are mixed.

The first sale promotion information and the second sale promotion information may include a coupon or an advertisement.

The preference information may include a preference or behavior pattern of the customer.

the preference information may be updated based on use of the first sale promotion information and the second sale promotion information by the customer.

The preference information may include a preference or behavior pattern of a group with which the customer shares an attribute.

the progress management unit may detect that the customer has used the first sale promotion information or the second sale promotion information based on a position of the terminal.

In addition, a terminal according to a second aspect of the present disclosure includes a communication unit configured to transmit preference information of a customer to an information provision apparatus, a display unit configured to display, on a screen, first sale promotion information, and second sale promotion information that matches the preference information at a higher level than that of the first sale promotion information, the first sale promotion information and the second sale promotion information being generated at the information provision apparatus, an input unit configured to receive a selection regarding the first sale promotion information and the second sale promotion information. The screen information is generated at the information provision apparatus. When the first sale promotion information and second sale promotion information that have been selected are used, the display unit is configured to change a display mode of the first sale promotion information and second sale promotion information used, and when a layout of the first sale promotion information and the second sale promotion information on the screen, of which the display mode has been changed, satisfies a predetermined condition, the communication unit is configured to receive additional sale promotion information.

An information provision method according to a third aspect of the present disclosure uses an information provision apparatus. The information provision method includes acquiring sale promotion information including at least first sale promotion information and second sale promotion information, transmitting, to a terminal of a customer, screen information having the first sale promotion information, and the second sale promotion information which matches preference information of the customer at a higher level than that of the first sale promotion information, detecting that the customer has used the first sale promotion information and the second sale promotion information, changing a display mode of the first sale promotion information and the second sale promotion information displayed on the screen of the terminal, providing additional sale promotion information to the terminal when a layout of the first sale promotion information and the second sale promotion information on the screen, of which the display mode has been changed, satisfies a predetermined condition.

With each aspect of the present disclosure, it is possible to more efficiently provide promotion information to a customer.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating an example of a configuration according to an embodiment;

FIG. 2 is a diagram illustrating a detailed example of a configuration of an information provision apparatus;

FIG. 3A is a sequence diagram illustrating an example in which the information provision apparatus acquires a customer's preference information, and the like;

FIG. 3B is a sequence diagram illustrating an example in which the information provision apparatus acquires promotion information;

FIG. 4 is a sequence diagram illustrating an example in which the information provision apparatus provides the promotion information to a mobile terminal;

FIG. 5A is a diagram to describe screen information;

FIG. 5B is a diagram to describe the screen information;

FIG. 5C is a diagram to describe the screen information;

FIG. 6 is a sequence diagram illustrating an example of using the promotion information by the mobile terminal;

FIG. 7 is a sequence diagram illustrating an example of using the promotion information by the mobile terminal;

FIG. 8A is a diagram illustrating an example of a modification of a display mode of a screen;

FIG. 8B is a diagram illustrating an example of a modification of the display mode of the screen; and

FIG. 9 is a sequence diagram illustrating an example in which a benefit provision unit provides additional promotion information.

### DETAILED DESCRIPTION OF EMBODIMENTS

Hereinbelow, an embodiment will be described in detail with reference to drawings.

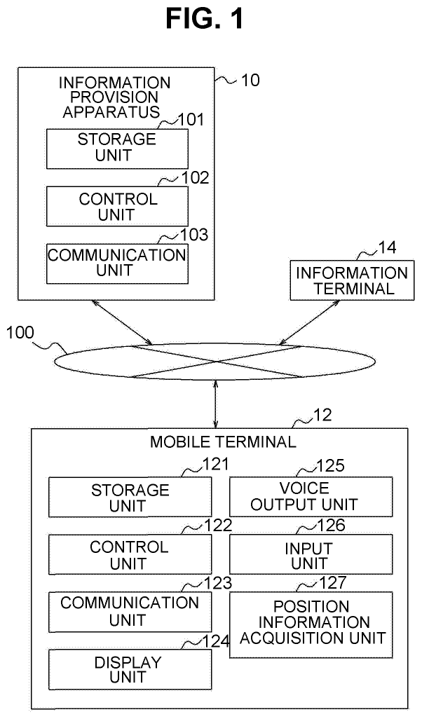

FIG. 1 is a diagram illustrating an example of a. configuration of the present embodiment. In the present embodiment, an information provision apparatus 10, a mobile terminal 12, and an information terminal 14 are connected via a communication network 100 to be capable of data communication with one another. A customer carries the mobile terminal 12. In addition, the information terminal 14 is installed in a place of sale promotion of a seller of goods or services. The place of sale promotion is, for example, a store or an event venue. Note that an information provision system according to the present embodiment includes the information provision apparatus 10 and the mobile terminal 12, and the mobile terminal 12 corresponds to a “terminal”. In such a configuration, the information provision apparatus 10 transmits, to the mobile terminal 12, sale promotion information to promote the sale of the goods or services at the place of sale promotion by the seller. The customer visits the place of sale promotion based on the sale promotion information, and purchases the goods or services using the sale promotion information.

The information provision apparatus 10 receives the sale promotion information from the information terminal 14, and transmits the sale promotion information to the mobile terminal 12. The information provision apparatus 10 is, for example, a server apparatus. The information provision apparatus 10 includes a storage unit 101, a control unit 102, and a communication unit 103.

The storage unit 101 stores a control and process program associated with a control and processing operation of the information provision apparatus 10. Further, the storage unit 101 temporarily stores various pieces of information regarding the control and processing operation of the information provision apparatus 10. Moreover, the storage unit 101 stores the sale promotion information, and the like. The storage unit 101 has, for example, a storage medium, such as a memory, an optical disk, a magnetic disk, and a control circuit thereof.

The control unit 102 controls an operation of the information provision apparatus 10 according to the control and process program. The control unit 102 has, for example, a general-purpose processor, or a processor dedicated to a specific process.

The communication unit 103 includes a communication interface corresponding to various communication standards and a control circuit thereof. The communication interface corresponds to, for example, a wired Local Area Network (LAN) standard, a wireless LAN standard, and the like. The communication unit 103 is connected to the communication network 100 in a wired or wireless manner. Through the communication unit 103, the information provision apparatus 10 is able to execute data communication with the mobile terminal 12 and the information terminal 14 via the communication network 100.

The mobile terminal 12 is a portable information and communication terminal. The mobile terminal 12 receives the sale promotion information from the information provision apparatus 10. The customer carries the mobile terminal 12 and uses the sale promotion information via the mobile terminal 12. The sale promotion information is, for example, an advertisement or coupon for sale promotion. The customer causes the mobile terminal 12 to display the advertisement for sale promotion, and perceives the place of sale promotion. Then the customer visits the place of sale promotion, and uses the coupon via the mobile terminal 12. The mobile terminal 12 includes a storage unit 121, a control unit 122, a communication unit 123, a display unit 124, a voice output unit 125, an input unit 126, and a position information acquisition unit 127.

The storage unit 121. stores a control and process program associated with the control and processing operation of the mobile terminal 12. Further, the storage unit 121 temporarily stores various pieces of information used in the control and processing operation of the mobile terminal 12. Moreover, the storage unit 121 stores sale promotion information, and the like. The storage unit 121 has, for example, a storage medium, such as a memory, and a control circuit thereof.

The control unit 122 controls the operation of the mobile terminal 12 according to the control and process program. The control unit 122 has, for example, a general-purpose processor, or a processor dedicated to a specific process.

The communication unit 123 includes a communication interface corresponding to various communication standards, and a control circuit thereof. The communication interface corresponds to, for example, a mobile communication standard such as Fourth. Generation mobile communication (4G), a near-field wireless communication standard such as Bluetooth®, a wired LAN standard, a wireless LAN standard, and the like. The communication unit 123, for example, is wirelessly connected to the communication network 100. Through the communication unit 123, the mobile terminal 12 executes data communication with the information provision apparatus 10 and the information terminal 14 via the communication network 100.

The display unit 124 displays a screen based on data generated by the control unit 122 or received by the communication unit 123. The display unit 124 includes a display and a control circuit thereof. The display is, for example, a panel display, such as a liquid crystal panel or an organic Electro-Luminescence (EL) panel.

The voice output unit 125 outputs, via audio, data generated by the control unit 122 or received by the communication unit 123. The voice output unit 125 includes a speaker that outputs audio corresponding to voice data and a control circuit thereof.

The input unit 126 includes an input interface that receives input by the customer and a control circuit thereof. The input interface has, for example, a touch panel integrally formed with the display unit 124. Further, the input interface has, for example, a keyboard that receives a character input. In addition, the input interface has, for example, a microphone that receives a voice input.

The position information acquisition unit 127 includes a Global Positioning System (GPS) receiver that receives a GPS signal from a GPS satellite. The control unit 122 derives the position (for example, latitude and longitude) of the mobile terminal 12 based on the GPS signal received by the position information acquisition unit 127.

The communication network 100 is, for example, any one or a combination of a LAN, a Wide Area Network (WAN), a mobile communication network, and the Internet.

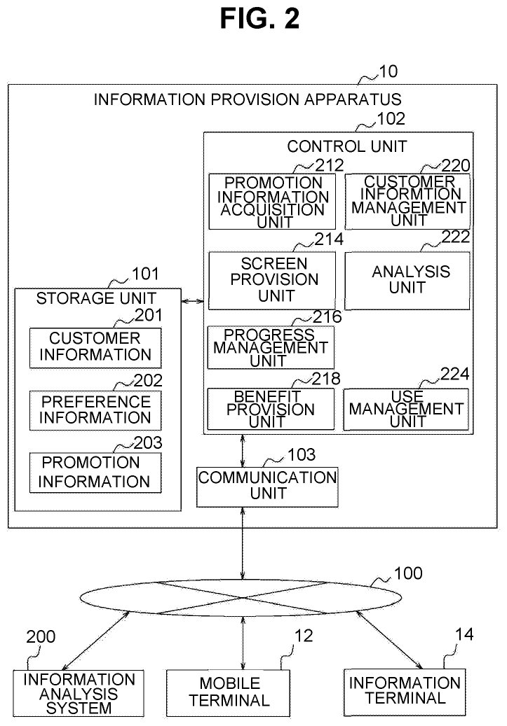

FIG. 2 is a diagram illustrating a detailed example of a configuration of the information provision apparatus 10.

The information provision apparatus 10 includes a sale promotion information acquisition unit 212, a screen provision unit 214, a progress management unit 216, a benefit provision unit 218, a customer information management unit 220, an analysis unit 222, and a use management unit 224. The function of each unit is implemented by the control unit 102 configured to execute a process corresponding to each unit. Operations of each unit will be described below.

In the information provision apparatus 10, the storage unit 101 includes customer information 201, preference information 202, and sale promotion information 203.

The customer information 201 is personal information, such as a customer ID, a password, and a name. The personal information may include characteristic data for authentication, such as a fingerprint or an iris. The personal information is acquired with the customer's consent in advance. For example, the customer transmits the personal information to the information provision apparatus 10, from the mobile terminal 12 and other information processing apparatuses.

The preference information 202 includes, for example, the customer's hobby, activity, food preference, behavior pattern, and the like. The behavior pattern includes, for example, a place where the customer frequently visits. The mobile terminal 12 periodically or frequently transmits its position information to the information provision apparatus 10, and the analysis unit 222 derives a frequently visited location from the position history of the mobile terminal 12 and deduces a place the customer frequently visits. Then the analysis unit 222 includes the deduced place in the preference information 202, and stores the preference information including the deduced place in the storage unit 101. Alternatively, it is also possible to deduce, based on the position history, a movement route the customer frequently uses, and to include, in the preference information 202, places within a predetermined distance or time range from the route.

The preference information 202 can be acquired, for example, from an information analysis system 200 that exists externally. The information analysis system 200 includes the result of analyzing, with the customer's consent, the customer's preference and behavior pattern from the customer's behavior history, outgoing information from a Social Network Service (SNS), and the like. Further, the information analysis system 200 includes the result of analyzing the preference or behavior pattern of a group with which the customer shares an attribute (for example, gender, age, occupation, and residence). The analysis unit 222, acquires, from the information analysis system 200 via the communication network 100, the result of analyzing the customer's preference and behavior pattern, or the result of analyzing the preference and behavior pattern of the group with which the customer shares an attribute, and stores the acquired result as preference information 202 in the storage unit 101. By doing so, it is possible to reduce the customer's burden to input preference information.

The sale promotion information 203 is transmitted from the information terminal of the seller 14. The sale promotion information acquisition unit 212 receives the sale promotion information 203 from the information terminal 14, and stores the sale promotion information 203 in the storage unit 101. Alternatively, for example, when the information provision apparatus 10 receives a request to generate sale promotion information 203 from the information terminal 14, the information provision apparatus 10 generates the sale promotion information 203 based on the request, and stores the generated sale promotion information 203 in the storage unit 101. In addition to seller information specifying the seller, the sale promotion information 203 includes various other pieces of information.

The sale promotion information 203 includes, for example, seller information, a date and time when the sale promotion information is available (a period, day of week, time slot), a time limit, a list of places of sale promotion, a location or URL of each place of sale promotion, a category and description of the goods or services, a delivery target, a delivery priority, a discount amount, and sale promotion use information.

The time limit refers to a time limit for arriving at the place of sale promotion, and includes, for example, a closing time of the place of sale promotion, an ending time of a service provided and a beginning time of an event to be staged.

Goods or services are categorized by, for example, tree-structured data of categories with different granularities. A category includes data on information composed of a root category, a subcategory, and a sub-subcategory, for example, “food-Japanese-sushi,” “food-Japanese-tempura,” “food-Italian-pasta,” “food-Italian-pizza,” “event-instant sale-clothes,” “event-instant sale-daily necessities,” “event-show-hero,” or “event-show-pop star.” The category may have a data structure that can match the preference information 202. Further, the granularity of information, the number of hierarchies, and the like, are not limited to the examples provided herein. In addition, a description on goods or services is displayed as, for example, a text or image of a description on sale promotion of the goods or services.

The delivery target is the amount of sale promotion information the seller desires to deliver, and includes, for example, a maximum number of deliveries and a minimum. number of deliveries. While the seller cannot expect an increase in sales due to the sale promotion when the number of coupons delivered is low, the profit rate decreases when the number of coupon users with the increased number of deliveries. Therefore, for example, when transmitting the sale promotion information 203 to the information provision apparatus 10 or registering the sale promotion information 203 therein, the seller discretionarily sets the number of deliveries to a level that will not result in a decrease in profit rate as the maximum delivery number, and discretionarily sets the number of deliveries to a level that can be expected to bring about an increase in sales as the minimum number.

Delivery priority is, for example, an order of priority in delivering sale promotion information, which is set by the sale promotion information acquisition unit 212. The delivery priority is set based in orders of, for example, how close the sale promotion information is to the time limit, how early the sale promotion information has been acquired, how small the discount amount is, how high the sale promotion target is, or how large the volume of the undelivered sale promotion information is in the same category. In addition, the delivery priority may, for example, be set in order according to how large the gap between the delivery target and the number of use of the sale promotion use information is (i.e., the number of coupon uses or the number of advertisement uses, which will be described below). Further, the seller may discretionarily set the delivery priority when transmitting the sale promotion information 203 from the information terminal 14.

The sale promotion information 203 may include an average price and a discount rate of goods or services at the place of sale promotion, instead of the discount amount.

The sale promotion use information is, for example, data regarding a coupon for purchasing goods or services at the place of sale promotion, the category, and the discount amount corresponding to each piece of the sale promotion information. The sale promotion use information is, for example, data for displaying a barcode or a QR code® that represents a discount amount. Further, the sale promotion use information is data regarding an advertisement about the place of sale promotion, the category, and the discount amount corresponding to each piece of the sale promotion information. The sale promotion use information is, for example, data for displaying a guide map for the place of sale promotion, or an image describing the goods or services.

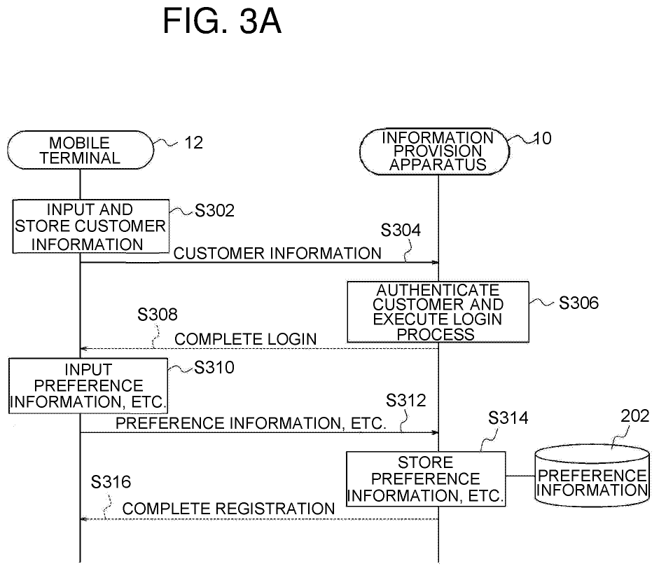

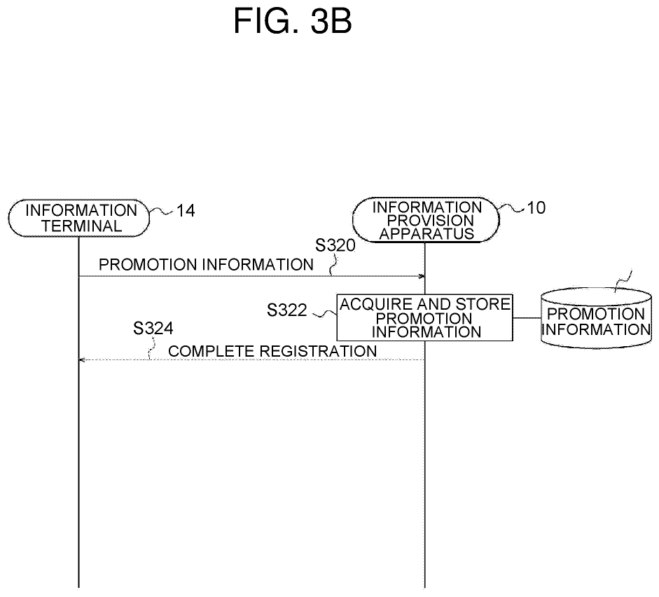

With reference to FIG. 3 to FIG. 9, sequences of operations of the information provision apparatus 10, and the like, of the present embodiment will be described.

FIG. 3A illustrates an example of a sequence in which the information provision apparatus 10 acquires the customer's preference information, and the like. The sequence of FIG. 3A is executed, for example, when the customer executes an initial setting in the mobile terminal 12. However, in the sequence of FIG. 3, an information processing apparatus, which can be connected to the communication network 100, such as a personal computer, may replace the mobile terminal 12.

The mobile terminal 12 receives the customer information including the customer ID input by the customer and stores the input customer information in the storage unit 121 (step S302). Then the mobile terminal 12 transmits the customer information to the information provision apparatus 10 (step S304). Then. the customer information management unit 220 of the information. provision apparatus 10 registers or authenticates the customer using the customer ID, and executes the log-in process (step S306). When the customer ID transmitted from the mobile terminal 12 is not stored in the storage unit 101 as customer information 201, the information provision apparatus 10 registers the customer as a new user, and when the customer ID is already stored, the information provision apparatus 10 causes the customer to be logged in as an existing user. Thereafter, the information provision apparatus 10 transmits a notification of completion of login to the mobile terminal 12 (step S308). Then the mobile terminal 12 receives an input of the preference information 202 by the customer (step S310). For example, the mobile terminal 12 acquires the customer's preference information 202 by presenting a questionnaire, or the like, to the customer, and receiving the customer's response regarding his or her selection on an answer sheet. Thereafter, the mobile terminal 12 transmits the preference information 202 to the information provision apparatus 10 (step S312). Then the information provision apparatus 10 stores, in the storage unit 101, the preference information 202 corresponding to the customer information 201 (step S314), and notifies the mobile terminal 12 of completion of registration of the preference information 202 (step S316).

FIG. 3B illustrates an example of a sequence in which the information provision apparatus 10 acquires the sale promotion information. The sequence of FIG. 3B is executed, for example, when the seller registers, in the information provision apparatus 10, via the information terminal 14, the sale promotion information that the seller desires to deliver.

The information terminal 14 transmits the sale promotion information to the information provision apparatus 10 (step S320). The sale promotion information acquisition unit 212 of the information provision apparatus 10 acquires the sale promotion information 203, and the information provision apparatus 10 stores the sale promotion information 203 in the storage unit 101 (step S322). In addition, here, for example, the sequence may be executed in the order in which the information terminal 14 first transmits a request for generating the sale promotion information 203 to the information provision apparatus 10, and the information provision apparatus 10 generates, based on the request, the sale promotion information 203, and stores the sale promotion information 203 in the storage unit 101. Thereafter, the information provision apparatus 10 notifies the information terminal 14 of completion of the registration of the sale promotion information 203 (step S324).

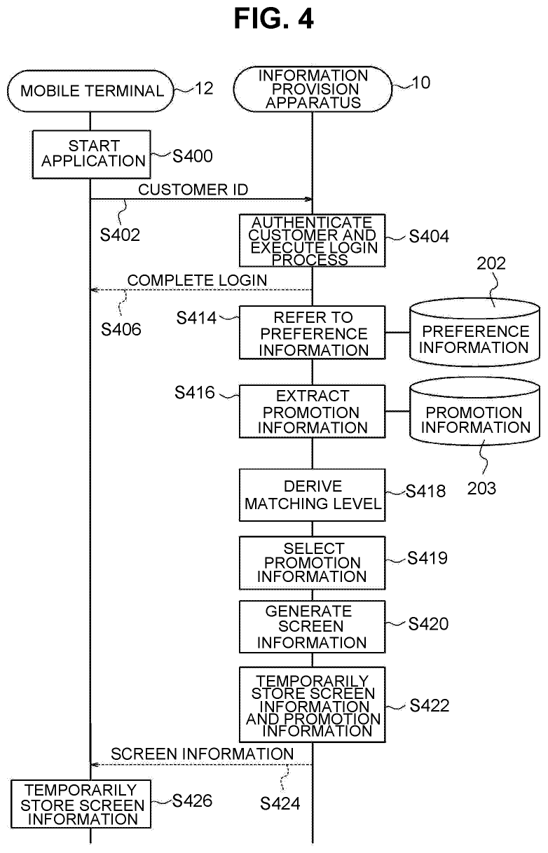

FIG. 4 illustrates an example of a sequence in which the information provision apparatus 10 provides the sale promotion information 203 to the mobile terminal 12. The sequence of FIG. 4 is executed, for example, when the customer starts an application showing the sale promotion information 203 on the mobile terminal 12.

When the application is started by the customer (step S400), the mobile terminal 12 transmits the customer ID to the information provision apparatus 10 (step S402). The setting of the customer ID in the mobile terminal 12 may be executed, for example, at the time of the initial setting of the application, or the like. Subsequently, the information provision apparatus 10 authenticates the customer using the customer ID and causes the customer to be logged in (step S404), and transmits the notification of completion of the login to the mobile terminal 12 (step S406).

Thereafter, the screen provision unit 214 of the information provision apparatus 10 executes steps S414 to S424. The information provision apparatus 10 refers to the customer's preference information 202 stored in the storage unit 101 (step S414). In addition, the information provision apparatus 10 extracts the sale promotion information 203 stored in the storage unit 101 (step S416). Step S414 and step S416 may be executed in reverse order. Subsequently, the information provision apparatus 10 matches the category of goods or services in each piece of sale promotion information 203 with the preference information 202, and derives a matching level indicating how closely the category matches the customer's preference information 202 (step S418). Here, the information provision apparatus 10 can acquire the current position of the mobile terminal 12, and correct the matching level according to the distance from the current position to the place of sale promotion corresponding to the sale promotion information 203. For example, when a plurality of pieces of sale promotion information 203 have the same matching level one another, the information provision apparatus 10 can correct the matching level such that the matching level of the place of sale promotion, which is closer to the current position of the mobile terminal 12 than the other places of sale promotion, is increased. Alternatively, when it is acknowledged that, based on the customer's behavior history, the customer has a tendency to prefer a nearby place of sale promotion, the information provision apparatus 10 may set the matching levels of the places of sale promotion in order of the shortest distance between the place of sale promotion and the current position of the mobile terminal 12 (i.e., in order of how easily the customer can visit the place of sale promotion).

Subsequently, the information provision apparatus 10 selects the sale promotion information 203 to be presented to the customer (step S419). Here, for example, the information provision apparatus 10 selects prioritized sale promotion information having a relatively high delivery priority and preferred sale promotion information that matches the customer's preference information 202 at a higher level than that of the prioritized sale promotion information, from other sale promotion information. The prioritized sale promotion information is, for example, sale promotion information of which the delivery priority is equal to or greater than a predetermined threshold value. Here, the threshold value can be discretionarily set, for example, to the median value or the upper 10% to 20% of the delivery priority range. In addition, the preferred sale promotion information is, for example, sale promotion information that matches the preference information 202 at a higher level than that of the prioritized sale promotion information.

Thereafter, the information provision apparatus 10 generates, using the prioritized sale promotion information and the preferred sale promotion information, screen information of a screen to be presented to the customer (step S420), temporarily stores the screen information and the sale promotion information 203 in the storage unit 101 (step S422), and transmits the screen information and the sale promotion information 203 to the mobile terminal 12 (step S424). Then the mobile terminal 12 receives the screen information and the sale promotion information 203, and stores the received screen information and the sale promotion information 203 in the storage unit 121 (step S426).

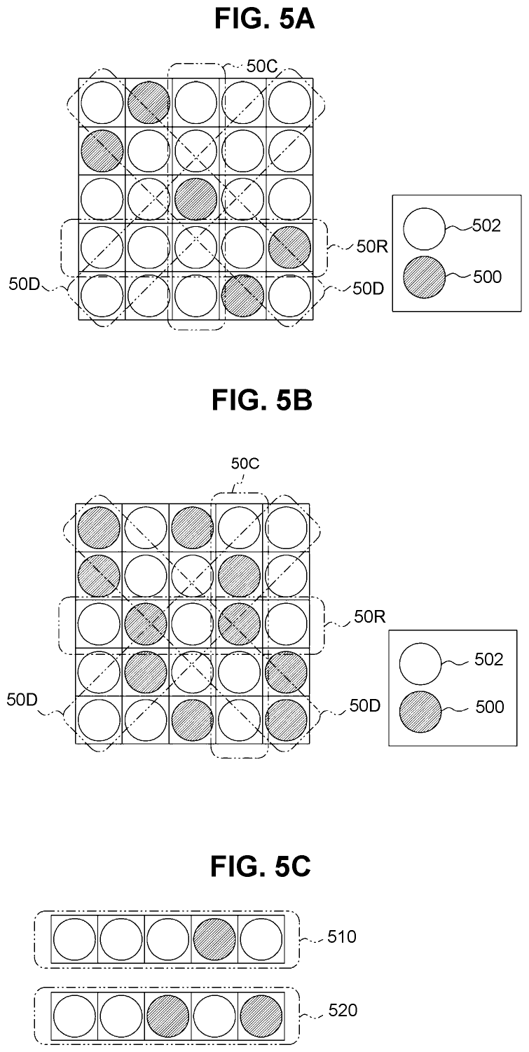

FIG. 5A to FIG. 5C are diagrams to describe the screen information generated in the screen provision unit 214. The screen corresponding to the screen information is, for example, a bingo sheet as illustrated in FIG. 5A and FIG. 5B, or, for example, a sheet of a stamp rally (an activity of collecting memorial stamps of stations, tourist attractions, and the like within a certain time frame or on a certain course) as illustrated in FIG. 5C. The screen provision unit 214 assigns and arranges each piece of the sale promotion information 203 to a square of the bingo sheet or the stamp rally sheet, and arranges the pieces of the sale promotion information 203 thereon. FIG. 5A to FIG. 5C illustrate examples of arrangement of prioritized sale promotion information 500 having a relatively high delivery priority, and the preferred sale promotion information 502 that matches the customer's preference information 202 at a higher level than that of the prioritized sale promotion information 500.

The prioritized sale promotion information 500 and the preferred sale promotion information 502 are schematically illustrated in FIG. 5A to FIG. 5C, in a manner that show the content of a sale promotion. For example, icon images representing sub-subcategories of goods or services are displayed in each square. In addition, when the prioritized sale promotion information 500 or the preferred sale promotion information 502 in each square is selected (for example, by a touch of an icon, or the like, on a touch screen), a description or an advertisement screen of the corresponding goods or services may be displayed on the screen.

By displaying the prioritized sale promotion information 500 and the preferred sale promotion information 502 in a manner that the customer can understand the content of each piece thereof, it is possible to prompt the customer to use the desired sale promotion information. Thereafter, according to the sequence that will be described below, when each piece of sale promotion information is used, the square corresponding to the used sale promotion information on the bingo sheet or the stamp rally sheet is validated. When the validated square satisfies a predetermined condition, a rule is determined for the customer in advance such that a benefit can be presented. A condition for benefit provision is forming a line in which the prioritized sale promotion information 500 and preferred sale promotion information 502 used are mixed. In other words, the condition for the benefit provision is, for example, to validate all the squares in any of a vertical, horizontal, or diagonal line of the bingo sheet, or to validate a predetermined number of squares in one line (a course) of the stamp rally sheet.

FIG. 5A and FIG. 5B illustrate examples of bingo sheets in which five squares are arranged in a row in each of the vertical and horizontal lines. Pieces of prioritized sale promotion information 500 and preferred sale promotion information 502 are arranged such that at least one square in each of the vertical, horizontal, and diagonal lines has prioritized sale promotion information 500. For example, in FIG. 5A, at least one square in any of the vertical, horizontal, and diagonal lines of the bingo sheet has prioritized sale promotion information 500. Further, for example, in FIG. 5B, at least two or more squares in any of the vertical, horizontal, and diagonal lines of the bingo sheet have prioritized sale promotion information 500. In this manner, by arranging the sale promotion information such that prioritized sales information 500 and preferred sale promotion information 502 are mixed in each of the vertical, horizontal, and diagonal lines, for example, when the customer validates all the squares in any of lines 50R, 50C, and 50D, the customer will have used not only the preferred sale promotion information 502 matching the customer's preference, but also at least one or more pieces of the prioritized sale promotion information 500. Therefore, the customer has more opportunities to use the prioritized sale promotion information 500 and the preferred sale promotion information 502. Moreover, the number of the squares arranged vertically and horizontally, and the number of pieces of prioritized sale promotion information 500 which are arranged in a mixed manner with the pieces of preferred sale promotion information 502 in each line, are not limited to the example described herein. Further, the number of lines to be completed as a condition for the benefit provision may be plural.

FIG. 5C illustrates an example of a stamp rally sheet of two courses, with five squares in each course. Pieces of prioritized sale promotion information 500 and pieces of preferred sale promotion information 502 are arranged such that at least one square of the five squares has prioritized sale promotion information 500. As such, by placing the pieces of the sale promotion information such that prioritized sale promotion information 500 and preferred sale promotion information 502 are mixed, for example, when the customer validates all the squares in any one of the courses 510 and 520, the customer will not only have used the preferred sale promotion information 500 matching the customer's preference, but will also have used at least one or more pieces of prioritized sale promotion information 502. Accordingly, the customer has more opportunities to use the prioritized sale promotion information 500 and the preferred sale promotion information 502. In addition, the number of the courses of the stamp rally sheet, the number of squares included in one course, and the number of pieces of prioritized sale promotion information 500, which are arranged in a mixed manner with pieces of preferred sale promotion information 502 in each course, are not limited to the example described herein. In addition, the order of validating the squares may be, for example, one by one from the left, or random.

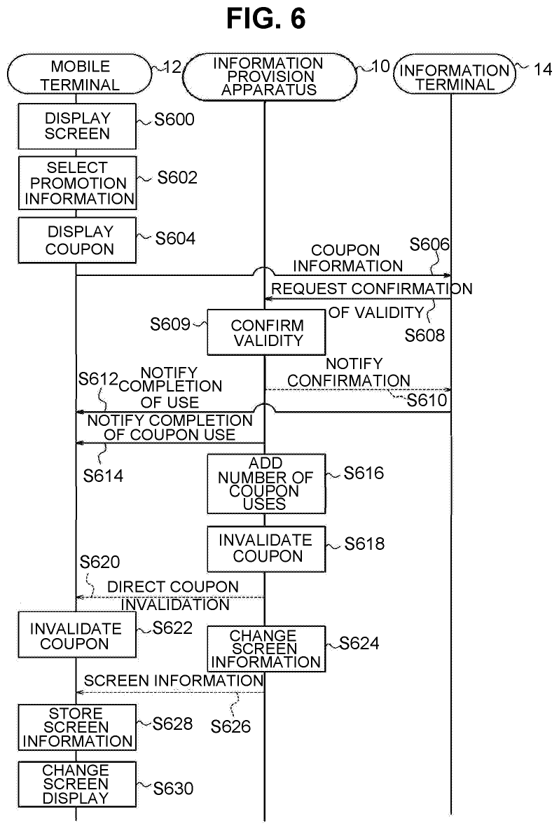

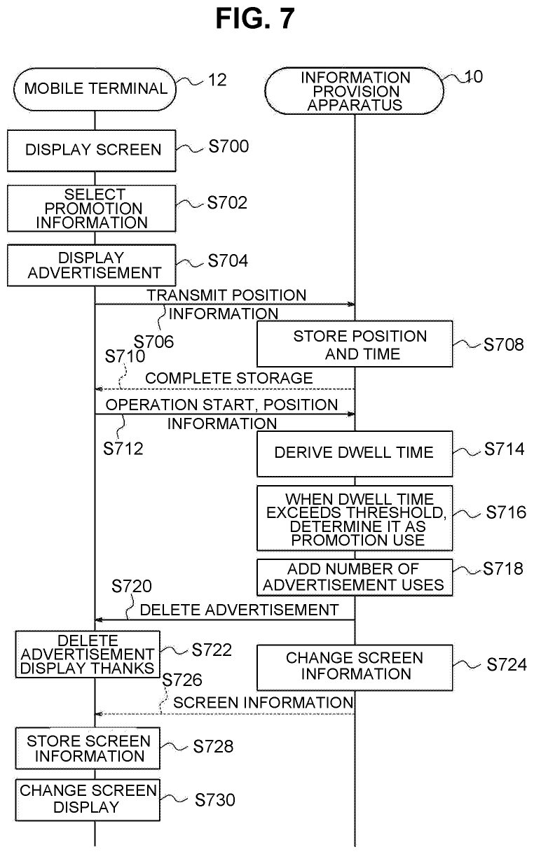

FIG. 6 and FIG. 7 illustrate examples of sequences in which the customer uses the sale promotion information 203 via the mobile terminal 12. The sequence of FIG. 6 or FIG. 7 is executed following the sequence of FIG. 4.

FIG. 6 illustrates a sequence of a case in which the sale promotion information 203 includes a coupon usable at the place of sale promotion. The mobile terminal 12, in response to the customer's operation, displays a screen showing the bingo sheet or stamp rally sheet illustrated in FIG. 5, based on the screen information and the sale promotion information 203 stored in the storage unit 121 (step S600). The mobile terminal 12 receives the desired sale promotion information selected by the customer (for example, by a touch of the icon on the screen) (step S602), and displays the coupon (step S604). The customer presents the coupon displayed on the mobile terminal 12 to the seller at the place of sale promotion, and transmits the coupon information from the mobile terminal 12 to the information terminal 14 of the seller (step S606). For example, a scanner connected to the information terminal 14 reads an identification code of the coupon, or the mobile terminal 12 establishes a near-field wireless connection with the information terminal 14, and wirelessly transmits the coupon information from the mobile terminal 12 to the information terminal 14.

Subsequently, the information terminal 14 transmits the coupon information to the information provision apparatus 10, and requests a validity confirmation (step S608). The information provision apparatus 10 checks the coupon information received from the information terminal 14 with the sale promotion information 203 stored in the information provision apparatus 10, and confirms the validity of the coupon (step S609). Here, it is detected whether the coupon has been used. Thereafter, the information provision apparatus 10 provides a notification of the confirmation (step S610). Then the information terminal 14 transmits, to the mobile terminal 12, a notification that the coupon has been used (step S612). Thereafter, the mobile terminal 12 transmits, to the information provision apparatus 10, the notification that the coupon has been used (step S614). In response to this, the use management unit 224 of the information provision apparatus 10 adds the number of coupon uses (step S616), and invalidates the data of the used coupons (step S618). Here, when a sale promotion information delivery operator, who manages the information provision apparatus 10, is on a contract to obtain payment from the seller according to the amount of the sale promotion information transmitted from the information provision apparatus 10, the payment is provided by the seller to the sale promotion information delivery operator according to the number of coupon uses which is added at step S616. Further, the information provision apparatus 10 can update the customer's preference information 202 according to the number of coupon uses. For example, the information provision apparatus 10 adds, to the preference information 202, the sale promotion information having the category of the goods or services in which the number of coupon uses is higher than a discretionarily set standard. By doing so, next time when sale promotion information is selected to be displayed on the screen, it is possible to match, at a high level, the sale promotion information having a category with high number of coupon uses, with the customer's preference information 202. Moreover, by doing so, it is possible to reduce the customer's burden to input preference information.

Subsequently, the information provision apparatus 10 transmits a coupon invalidation direction to the mobile terminal 12 (step S620). Then the mobile terminal 12 invalidates the data of the used coupon (step S622) such that the same coupon may not be reused. In addition, the progress management unit 216 of the information provision apparatus 10 changes the screen information so as to change a display mode of the used sale promotion information 203 on the screen that is displayed by the mobile terminal 12 (step S624). Thereafter, the information provision apparatus 10 transmits the changed screen information to the mobile terminal 12 (step S626). Then the mobile terminal 12 stores the received screen information in the storage unit 121 (step S628), and changes screen display based on the stored screen information (step S630).

FIG. 7 illustrates a modification of the sequence illustrated in FIG. 6, and illustrates a sequence in which the sale promotion information 203 includes an advertisement. In response to an operation of the customer, the mobile terminal 12 displays, based on the screen information stored in the storage unit 121, a screen showing the bingo sheet or the stamp rally sheet as illustrated in FIG. 5 (step S700). The mobile terminal 12 receives the desired sale promotion information selected by the customer (step S702), and displays an advertisement (step S704). Then the mobile terminal 12 transmits position information thereof to the information provision apparatus 10 (step S706). The mobile terminal 12 may transmit the position information to the information provision apparatus 10 after displaying the advertisement, or transmit usual position information to the information provision apparatus 10. The information provision apparatus 10 stores, in the storage unit 101, the received position information and the time of reception of the position information (step S708), and notifies the mobile terminal 12 of completion of the storage (step S710).

Subsequently, when the information provision apparatus 10 receives, from the mobile terminal 12, the notification of a start of a next operation by the customer and position information at the time of the notification (step S712), the information provision apparatus 10 derives the customer's dwell time from the received position information and the time of reception of the position information (step S714). The notification of the start of the operation by customer is transmitted, for example, in response to a display of another advertisement, a restarting of the application, the login following a restarting of the mobile terminal 12, or the like. Thereafter, when the latest position information matches the place of sale promotion, and the derived dwell time exceeds a predetermined threshold value, the information provision apparatus 10 determines that the sale promotion information has been used (step S716). In other words, the information provision apparatus 10 determines that the customer attracted by the advertisement has visited the place of sale promotion and stayed in the place of sale promotion for a time period which represents a high probability that the customer has purchased the goods or services. Note that the position information may match the latest position information within a certain range (for example, within a 100 m radius from the place of sale promotion). In addition, the predetermined threshold value regarding the time the customer stayed in the place of sale promotion is the dwell time from which it can be determined that the customer may have, for example, viewed or purchased the desired goods or services (for example, 15 minutes or more), and is discretionarily set,.

Subsequently, the use management unit 224 of the information provision apparatus 10 adds the number of advertisement uses (step S718). Here, in a case in which the sale promotion information delivery operator, who manages the information provision apparatus 10, is on a contract to obtain payment from the seller according to the amount of the sale promotion information transmitted from the information provision apparatus 10, payment is provided by the seller to the sale promotion information delivery operator according to the number of advertisement uses, which is added at step S718. Further, the information provision apparatus 10 can update the customer's preference information 202 according to the number of the advertisement uses. For example, the information provision apparatus 10 adds, to the preference information 202, the sale promotion information having the category of the goods or services in which the number of advertisement uses is higher than a discretionarily set standard. By doing so, next time when sale promotion information is selected to be displayed on the screen, it is possible to match, at a high level, the sale promotion information having a category with a high number of advertisement uses, with the customer's preference information 202. Moreover, by doing so, it is possible to reduce the customer's burden to input preference information.

Subsequently, the information provision apparatus 10 transmits an advertisement deletion direction to the mobile terminal 12 (step S720). Then the mobile terminal 12 deletes the used advertisement, or displays a message of thanks for visiting the store (step S722). Further, the progress management unit 216 of the information provision apparatus 10 changes the screen information so as to change the display mode of the used sale promotion information on the screen that is displayed by the mobile terminal 12 (step S724). Thereafter, the information provision apparatus 10 transmits the changed screen information to the mobile terminal 12 (step S726). Then the mobile terminal 12 stores the received screen information in the storage unit 121 (step S728), and changes the screen display based on the stored screen information (step S730).

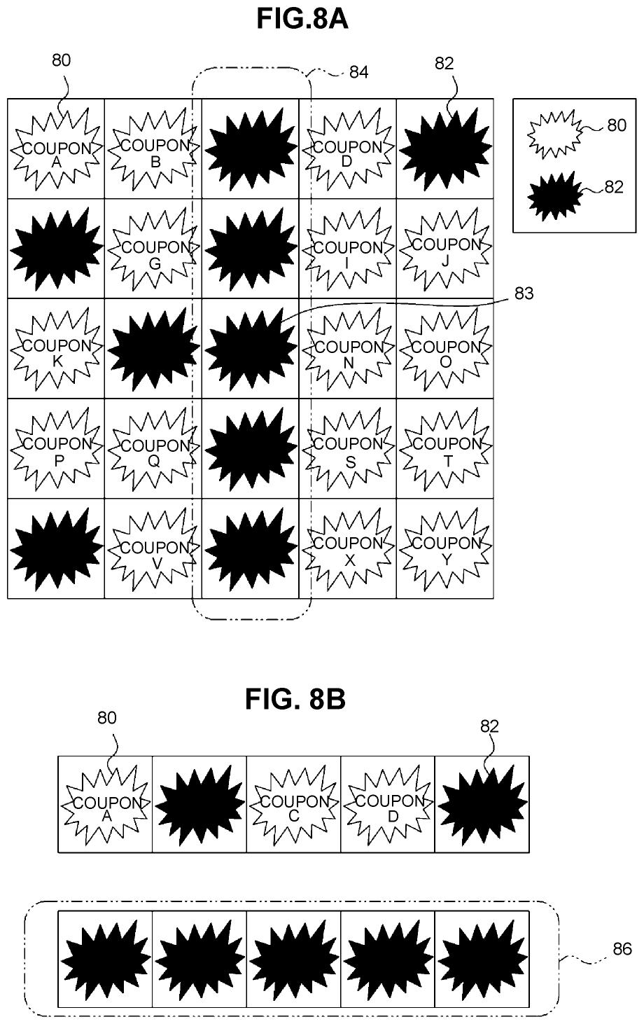

FIG. 8A and FIG. 8B illustrate examples of the modifications of the display mode of the screen. The bingo sheet of FIG. 8A includes squares displaying a mode 80 corresponding to unused sale promotion information, and squares displaying a mode 82 corresponding to validated sale promotion information that has been used. Further, the stamp rally sheet of FIG. 8B includes squares displaying an unused mode 80, and squares displaying a validated mode 82. FIG. 8A and FIG. 8B schematically illustrate the mode 80 representing the unused sale promotion information, and the mode 80 is, for example, an icon representing the content of each piece of sale promotion information. In the bingo sheet and the stamp rally sheet, any square may be set as bonus square 83 which has already been used.

With the above display mode, the customer can select which sale promotion information to use next while visually confirming the sale promotion information that has been validated. Here, it can be expected that, due to the sale promotion information that has been validated, the customer will be incentivized to attempt to satisfy the benefit provision condition (for example, completing a line in the bingo sheet, or accomplishing a course in the stamp rally sheet). Accordingly, it is possible to provide the customer with an opportunity to select not only sale promotion information matching the customer's preference, but also sale promotion information with a high delivery priority. When the validated sale promotion information satisfies the benefit provision condition (for example, completion of line 84 or accomplishment of course 86), the benefit provision unit 218 provides additional sale promotion information to the customer's mobile terminal 12.

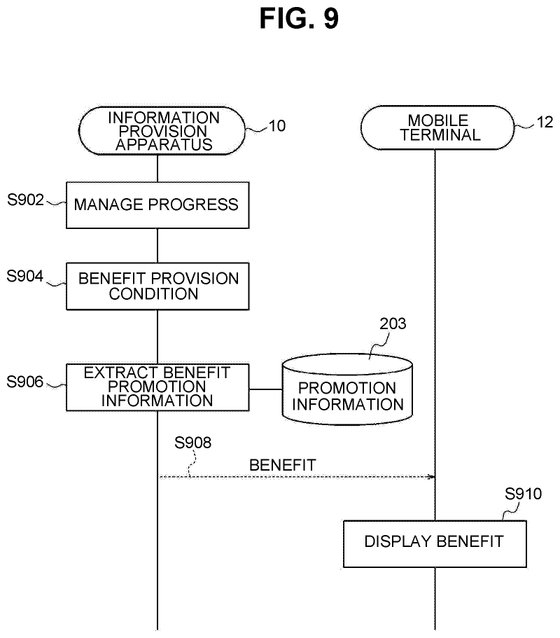

FIG. 9 illustrates an example of a sequence in which the benefit provision unit 218 provides additional sale promotion information 203. The sequence of FIG. 9 is executed after the sequence of FIG. 6 or FIG. 7, in other words, when the sale promotion information has been used. The progress management unit 216 of the information provision apparatus 10 manages the progress of the screen representing the sale promotion information (for example, the bingo sheet or the stamp rally sheet) (step S902). For example, the information provision apparatus 10 determines whether the validated square satisfies the benefit provision condition. Thereafter, when it is determined that the benefit provision condition has been achieved (step S904), the benefit provision unit 218 of the information provision apparatus 10 extracts additional sale promotion information as a benefit, from the sale promotion information 203 of the storage unit 101 (step S906). The additional sale promotion information as a benefit may be ordinary sale promotion information, or sale promotion information with a large discount amount. Thereafter, the information provision apparatus 10 transmits the sale promotion information as a benefit to the mobile terminal 12 (step S908). Then the mobile terminal 12 displays the benefit (step S910), and provides the benefit to the customer.

With the present embodiment, the sale promotion information can be provided to the customer more efficiently than the related art of the same field. For example, there is a technology that delivers, to a customer's mobile terminal, a bingo sheet having a square which is validated when the customer visits a store. Although such technology provides the customer with the amusement of the bingo game, the customer selects goods or services, and stores based on his or her own preference. In addition, another technology selects a coupon matching a customer's preference or usable at a store in the vicinity of the customer's current position, and provides the selected coupon to the customer. In this technology, however, the customer also ends up selecting a store based on his or her own preference when using the provided coupon. Moreover, even when the customer prefers a store in the vicinity of his or her current position, it does not change the fact that the customer selects the store based on his or her own preference. In the above related art, it is difficult to provide sale promotion information that does not match the customer's preference. Then the sale promotion information to be delivered may pile up, and such a pile-up can put pressure on the revenue of the sale promotion information delivery operator. Compared to the above related art, the present embodiment can more efficiently provide the sale promotion information to the customer. Specifically, the present embodiment can prompt the customer to use sale promotion information with a high delivery priority, by mixing, for example, sale promotion information that may have a high delivery priority but does not match the customer's preference, or the like, with sale promotion information that matches the customer's preference at a higher level, in the line of the bingo sheet or the course of the stamp rally sheet, thus incentivizing the customer to complete the bingo or accomplish the stamp rally.

### Embodiment

In one embodiment, it is possible to deliver service sale promotion information of a store that is situated away from main traffic routes. For example, amusement facilities such as sports climbing centers have a low distribution level and need large-scale equipment, and thus arc located away from the ordinary movement ranges of many customers, such as town centers. When attempting to deliver sale promotion information of such amusement facilities to customers, there is a concern that the sale promotion information may not be delivered to the customers for reasons such as unpopularity or difficulty of access due to the distant location of the facilities, and this may result in a pile-up of the sale promotion information. Meanwhile, the sale promotion information of a restaurant, store, or the like, which the customer frequently visits, matches the customer's preference at a high level.

The information provision apparatus 10 mixes a coupon or advertisement of the sports climbing center and a coupon or advertisement of the restaurant, store, or the like, which matches the customer's preference, generates the screen information to display the screen showing the bingo sheet or the stamp rally sheet, and transmits the generated screen information to the mobile terminal 12. Then the mobile terminal 12 displays the bingo sheet or stamp rally sheet to the customer, thereby prompting the customer to use the sports climbing center. Therefore, even sale promotion information of unpopular goods or services having a low distribution level, stores which are difficult to access, or the like, can be mixed with sale promotion information that matches the customer's preference at a higher level, and be provided to the customer such that the customer can be prompted to use them through an incentive, such as the bingo or stamp rally.

The present embodiment has been described based on the drawings and an embodiment. However, it is to be noted by a person skilled in the art that variations and modifications thereof are easily executed based on the present disclosure. Therefore, it is also to be noted that such variations or modifications can be applied to the embodiments. For example, functions, and the like, included in each element, each step, and the like, can be rearranged so as not to be logically contradictory, and it is possible to combine a plurality of elements, steps, or the like into one, or divide them.

In addition, many features of the present embodiment are represented as a series of operations executed by a computer system and other hardware capable of executing a program direction. However, in addition to the example described above, the computer and other hardware include, for example, a general-purpose computer, a personal computer, a dedicated computer, a workstation, a Personal Communications System (PCS), a mobile (cellular) phone, mobile equipment having a data processing function, an RFID receiver, a laptop computer, a tablet-type computer, and other programmable data processing apparatuses. Further, various operations may be executed by a dedicated circuit mounted with a program direction, or a logic block or a program module executed by one or more processors. Here, one or more processors include, for example, any combination of one or more microprocessors, a Central Processing Unit (CPU), an Application Specific Integrated Circuit (ASIC), a Digital Signal Processor (DSP), a Programmable Logic Device (PLD), a Field Programmable Gate Array (FPGA), a controller, a microcontroller, and the like. In addition, the memory can be installed inside or outside the processor or the processing unit. The memory means all kind of memory, such as long-term memory, short-term memory, volatile memory, and non-volatile memory. The number of memories or the type of information stored is not limited.

Moreover, included in the communication network according to the present disclosure are, in addition to the above-described example, an ad hoc network, a LAN, a Metropolitan Area Network (MAN), a cellular network, a Wireless Personal Area Network (WPAN), a Public Switched Telephone Network (PSTN), a Terrestrial Wireless Network (TWN), an optical network, or other network, or any combination thereof. Included in the constituent elements of the wireless network are, for example, an access point (for example, a Wi-Fi access point), femtocells, and the like. Further, a wireless communication apparatus can be connected to a wireless network using Wi-Fi®, Bluetooth®, cellular communication technology, or other wireless technologies and technology standards.

In addition, the input interface of the input unit includes, but is not limited to, a keyboard, a touch screen, a pointing device, and the like.

As such, various features in the present disclosure, can be executed in many different aspects, and such aspects are all included within the scope of the present embodiment.

What is claimed is:

1. An information provision apparatus comprising:
an acquisition unit configured to acquire sale promotion information including at least first sale promotion information and second sale promotion information;
a storage unit configured to have preference information of a customer;
a screen provision unit configured to transmit, to a terminal of the customer, screen information having the first sale promotion information, and the second sale promotion information that matches the preference information at a higher level than that of the first sale promotion information;
a progress management unit configured to detect that the customer has used the first sale promotion information and the second sale promotion information, and to change a display mode of the first sale promotion information and the second sale promotion information that are displayed on the screen of the terminal based on the screen information; and
a benefit provision unit configured to provide additional sale promotion information to the terminal when a layout of the first sale promotion information and the second sale promotion information on the screen, of which the display mode has been changed, satisfies a predetermined condition.

2. The information provision apparatus according to claim I, wherein the predetermined condition is forming a line in which the first sale promotion information and second sale promotion information used are mixed.

3. The information provision apparatus according to claim 1, wherein the first sale promotion information and the second sale promotion information include a coupon or an advertisement.

4. The information provision apparatus according to claim 1, wherein the preference information includes a preference or behavior pattern of the customer.

5. The information provision apparatus according to claim 1, wherein the preference information is updated based on use of the first sale promotion information and the second sale promotion information by the customer.

6. The information provision information according to claim 1, wherein the preference information includes a preference or behavior pattern of a group with which the customer shares an attribute.

7. The information provision apparatus according to claim 1, wherein the progress management unit is configured to detect that the customer has used the first sale promotion information or the second sale promotion information based on a position of the terminal.

8. A terminal comprising:
a communication unit configured to transmit preference information of a customer to an information provision apparatus;
a display unit configured to display, on a screen, first sale promotion information, and second sale promotion information that matches the preference information at a higher level than that of the first sale promotion information, the first sale promotion information and the second sale promotion information being generated at the information provision apparatus; and
an input unit configured to receive a selection regarding the first sale promotion information and the second sale promotion information;
wherein when the first sale promotion information and second sale promotion information that have been selected are used, the display unit is configured to change a display mode of the first sale promotion information and second sale promotion information used, and when a layout of the first sale promotion information and the second sale promotion information on the screen, of which the display mode has been changed, satisfies a predetermined condition, the communication unit is configured to receive additional sale promotion information.

9. An information provision method using an information provision apparatus, the information provision method comprising:
acquiring sale promotion information including at least first sale promotion information and second sale promotion information;
transmitting, to a terminal of a customer, screen information having the first sale promotion information, and the second sale promotion information which matches preference information of the customer at a higher level than that of the first sale promotion information;
detecting that the customer has used the first sale promotion information and the second sale promotion information;
changing a display mode of the first sale promotion information and the second sale promotion information displayed on the screen of the terminal; and
providing additional sale promotion information to the terminal when a layout of the first sale promotion information and the second sale promotion information on the screen, of which the display mode has been changed, satisfies a predetermined condition.
